(19) United States
(12) Patent Application Publication
(10) Pub. No.: US 2025/0209543 A1
(43) Pub. Date: Jun. 26, 2025

(54) ARTIFICIAL INTELLIGENCE DRIVEN SYSTEM FOR ACCELERATED SOFTWARE APPLICATION CONTENT GENERATION

(71) Applicant: INTUIT INC., Mountain View, CA (US)

(72) Inventors: Malathy MUTHU, The Woodlands, TX (US); Corinne L. FINEGAN, Los Altos, CA (US); Richard J. BECKER, Alberta (CA); Goutham KALLEPALLI, Sunnyvale, CA (US); Olabode IDOWU, Alberta (CA); Karelia Del Carmen PENA-PENA, Wilmington, DE (US); Ankita SINHA, Mountain View, CA (US)

(21) Appl. No.: 18/392,137

(22) Filed: Dec. 21, 2023

(51) Int. Cl. G06Q 40/12; G06N 20/00

(52) U.S. Cl. CPC G06Q 40/123; G06N 20/00

(57) ABSTRACT

Aspects of the present disclosure relate to generating software application content related to forms. Embodiments include generating a first prompt comprising instructions to extract a first type of information from a form and providing the first prompt to a first machine learning model. Embodiments further include receiving, from the first machine learning model, first extracted information. Embodiments further include generating a second prompt comprising instructions to extract a second type of information from the form and providing the second prompt to the first machine learning model. Embodiments further include receiving, from the first machine learning model, second extracted information. Embodiments further include generating a third prompt comprising instructions to generate software application content based on the first and second extracted information and providing the third prompt to a second machine learning model. Embodiments further include receiving, from the second machine learning model, generated software application content.

### INTRODUCTION

Aspects of the present disclosure relate to techniques for accelerating the process of generating software application content. In particular, techniques described herein involve using artificial intelligence and prompt engineering to generate new software application content based on forms, existing software application content, and other documents related to forms.

### BACKGROUND

Every year millions of people, businesses, and organizations around the world utilize software applications to assist with countless aspects of life. For example, many individuals and businesses rely on software applications for performing complex activities such as filing tax returns or completing loan applications. These software applications simplify what would otherwise be complex and tedious tasks.

Software applications often serve purposes that involve assisting users with completing complicated forms. For example, millions of people rely on tax software applications to assist them with completing and filing their income tax returns. Creating tax software applications and keeping such applications up to date requires an understanding of thousands of tax forms, as well as thousands of pages of filing instructions and other documents that are related to the forms. This makes creating tax software content an arduous task that requires an immense amount of manual labor to perform. Also, the complexity and length of the task raises a chance for human error. The challenges inherent in creating tax software application content are inherent in creating software application content for applications related to other types of forms as well. For instance, creating content for software applications that help users complete loan-related forms or medical forms requires significant expertise and effort as well. Furthermore, there are many challenges associated with automating aspects of form-based software application content generation. For example, while existing machine learning technologies are capable of generating content, such technologies are not equipped to handle the complexities of extracting information from dense forms such as tax forms and generating content based on this information.

Thus, there is a need in the art for improved techniques of generating software application content for software applications that involve forms.

### BRIEF SUMMARY

Certain embodiments provide a method for generating software application content related to forms. The method generally includes: generating a first prompt comprising instructions to extract a first type of information from a form based on an embedding of the form; providing the first prompt to a first machine learning model that has been trained for data extraction based on embeddings; receiving, from the first machine learning model in response to the first prompt, first extracted information from the form that corresponds to the first type of information; generating a second prompt comprising instructions to extract a second type of information from the form based on the first extracted information; providing the second prompt to the first machine learning model; receiving, from the first machine learning model in response to the second prompt, second extracted information from the form that corresponds to the second type of information; generating a third prompt comprising instructions to generate software application content based on the first extracted information and the second extracted information; providing the third prompt to a second machine learning model that has been trained for software application content generation; and receiving, from the second machine learning model in response to the third prompt, generated software application content that is based on the first extracted information and the second extracted information.

Other embodiments provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts an example of computing components related to generating software application content.

FIG. 2 depicts an example of computing components related to generating software application content.

FIG. 3 depicts an example of a form and a document related to a form that may be used to generate software application content.

FIG. 4 depicts example operations related to generating software application content.

FIG. 5 depicts an example of a processing system for generating software application content.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for generating software application content.

According to certain embodiments, one more machine learning models are used in a process for automatically generating software application content based on data in documents such as forms and related documents. In some cases, one or more prompts are dynamically generated and provided to one or more machine learning models in order to extract information from documents (e.g., a form and related documents) and to generate application content based on the extracted information.

Prompts are generally used to direct a machine learning model to perform one or more desired functions. A prompt may be based on a template. For example, the template may comprise natural language instructions to “extract insert form part here from the provided form.” The template may be populated based on a desired action for the model, or based on information to be extracted by the model, in order to generate a prompt. For example, if it is desired for a model to extract field names from the form, then “field names” may be inserted into the above prompt template, resulting in a prompt that instructs a machine learning model to “extract field names from the provided form.”

In some embodiments, embeddings are used to aid a machine learning model in extracting information from a form. An embedding generally refers to a vector representation of an entity that represents the entity as a vector in n-dimensional space such that similar entities are represented by vectors that are close to one another in the n-dimensional space. Embeddings may be generated through the use of an embedding model, such as a neural network or other type of machine learning model that learns a representation (embedding) for an entity through a training process that trains the neural network based on a data set, such as a plurality of features of a plurality of entities. Forms are generally any type of document that a user may complete by providing information to the document. For example, loan application forms are documents that require applicants to populate the document with information such as the applicant's name and income level. Also, in certain embodiments, embeddings may be used to aid a machine learning model in determining whether other documents contain information related to a form. If the other documents contain information related to the form, the embeddings may then be used to aid the machine learning model in extracting information from the other documents. Documents that contain information related to forms may generally include any type of document that contains information that may be relevant to assisting a user with completing the forms. For example, statutes that address Medicare eligibility may be considered documents that contain information related to a medical form. Further, embeddings of forms and other documents may be used to generate prompts.

According to certain embodiments, a first prompt may be generated and provided to a first machine learning model. The first prompt may include instructions to extract a first type of information from a form. The first type of information may be, for example, fields of the form. Fields may include spaces for entering a user's name, date of birth, social security number, income, and/or the like. Fields may also include multiple choice questions. For example, a tax form may have a field that asks users if anybody claims the user as a dependent. If somebody claims the user as a dependent, the user would select “yes” as the answer to the question. Providing the first machine learning model with a prompt that asks it to extract fields from the form may result in the first machine learning model extracting information necessary to determine what fields the form contains (e.g. a name field, a date of birth field, etc.).

In some embodiments, a first machine learning model may be trained to extract information from forms and/or other documents based on embeddings of the forms and/or the other documents. As an example, the first machine learning model may comprise a natural language processing model such as a large language model. The first machine learning model may, for example, be provided with an embedding of a tax form and a prompt that instructs it to extract a first type of information from the form. For example, as discussed above, the first type of information indicated by the prompt may be fields of the form. Based on this prompt and the embedding of the form, the first machine learning model would then extract information necessary to determine the fields of the form, such as a name field, an address field, an income field, etc.

According to certain embodiments, a second prompt may be generated and provided to the first machine learning model. The second prompt may include instructions to extract a second type of information from a form. The second type of information may be, for example, information about extracted fields. As an example, the information about a particular field may include instructions on what actions to take based on the user's entry to the field. For instance, a tax form may include instructions for a user to fill out a different form if the income they enter into a particular field is above a certain level. Based on the second prompt and the embedding of the form, the first machine learning model would then extract information about the extracted fields from the form, such as information regarding whether a user should fill out another form based on their entry to a field.

Certain embodiments provide for the first machine learning model to extract information from one or more other documents related to the form. To do this, the machine learning model may first determine whether the other documents contain information related to the form based on the embeddings of the other documents and the first and second information extracted from the form. This determination may be made by comparing the semantic similarity of the embeddings to the first and second information. If the first machine learning model determines that a document contains information related to a form, the first machine learning model may then extract information from the document. The other documents may include, for example, filing instructions for the form, software application content from a software application related to the form, and/or the like. The information may include software application metadata associated with a document, interview questions, the filing instructions, and/or the like. For a tax form, the other documents may include IRS tax filing instructions, and the related information may be the tax filing instructions within the document.

In some embodiments, a third prompt may be generated. This prompt may include instructions to generate software application content based on the first extracted information and the second extracted information. In certain embodiments, information related to the form extracted from other documents may also be used to generate the software application content. The software application content may, for example, include an artifact that contains one or more types of content that is based on the extracted information. For example, the content may include interview questions, instructions, and/or other types of content. The generated content may enable a software application to ask users questions based on the information extracted from the form. For example, if a form contains a social security number field, the application may ask users for their social security numbers. As another example, if a form says that a user must fill out a different form if their income is above a certain level, then the application may prompt the user to fill out the different form based on an indication that the user's income is above that level.

According to some embodiments, a second machine learning model may be trained to generate software application content based on the third prompt and the first and second extracted information. As an example, the generated software application content may include software application code. Also, the software application content may include other content related to a software application, such as interview questions designed to automatically guide a user through populating a form or completing an application task related to the form. The software application content may be generated in a standard file format, such as JavaScript Object Notation (JSON). The second machine learning model may be, for example, a generative model such as a Generative Adversarial Network (GAN) or a Variational Autoencoder (VAE). The training process for the second machine learning model may include, for example, training or fine-tuning the second machine learning model using existing software application content. The training may also include providing the machine learning model with prompts and embeddings of forms used to generate the existing software application content. The training enables the second machine learning model to generate software application content based on the extracted information that is consistent with existing software application content. In some embodiments, a pre-trained model may be further trained (e.g., fine-tuned) by receiving user feedback in response to generated software application content. This allows the second machine learning model to be continuously improved and retrained based on newly generated software application content and user feedback.

In certain embodiments, a user feedback engine may be used to collect and process user feedback. The feedback may be an answer to a multiple choice question about the quality of the generated software application content. The feedback may be natural language feedback. The feedback engine may include a natural language processing model such as a large language model or another language processing technique. A natural language processing model may be applied to natural language feedback in order to determine what the user liked or did not like about the generated software application content as well as any issues that need to be addressed, such as formatting. The information gathered by the feedback engine may then be used to train the second machine learning model. Feedback may also be received in the form of a user accepting or rejecting automatically generated software application content, or a user modifying automatically generated software application content.

According to some embodiments, prompts may be generated by a prompt generation engine. Also, the prompt generation may be achieved by populating templates based on embeddings of documents and information extracted from documents (e.g., filling in the templates based on extracted information or a determination based on the embedding). The prompt generation engine may generate prompts based on an indication of desired intent for a machine learning model. For example, if it is desired for the first machine learning model to extract a first type of information, the prompt generation engine may be configured to provide the first machine learning model with a prompt that directs the first machine learning model to extract a first type of information. The prompt generation engine may generate prompts based on information extracted from documents. For example, if extracted information indicates that a form asks for a user's social security number, the prompt generation engine may generate a prompt containing instructions to generate software application content that asks a user to provide their social security number.

Embodiments of the present disclosure provide numerous technical and practical effects and benefits. For instance, creating software application content related to complex forms can require reviewing thousands of forms, and thousands of pages of dense information related to the forms. New forms and documents related to the forms may be published at any time, resulting in a persistent need for new software application content based on a growing set of information. The complexity and the amount of relevant information, combined with the complexity of software programming, greatly increase the risk of human error in manually creating software application content based on forms. Manually creating software application content based on forms without error requires a substantial amount of labor and expertise. Furthermore, automatically generating software application content using existing machine learning technologies poses significant challenges as well. Existing machine learning technologies are not tailored to efficiently and accurately extract information from dense forms and related documents, nor are they tailored to efficiently and accurately generate software application content based on the extracted information. By utilizing embeddings, prompts, and machine learning techniques in a particular process, embodiments of the present disclosure enable what could not be done previously (e.g., automated generation of accurate software application content based on forms and related documents) because existing machine learning technologies and associated processes were not tailored to efficiently and accurately extract information from complex forms and generate software application content based on the extracted information. Furthermore, the accuracy and efficiency achieved by embodiments of the present disclosure represents an improvement to computer technology-utilizing the teachings of the present disclosure will result in fewer processing resources being required to generate software application content. Also, the accuracy and efficiency of techniques described herein are continuously improved by user feedback in response to automatically generated software application content.

Additionally, by generating software application content in an accurate manner that is continuously improved based on training and user feedback, the present disclosure further conserves processor resources that would otherwise be used in generating inaccurate software application content and processing corrections to such inaccurate content. Also, this continuously improving accuracy conserves processor resources that would otherwise be wasted by executing or otherwise utilizing inaccurate software application content.

### Example Components Related to Automatically Generating Software Application Content

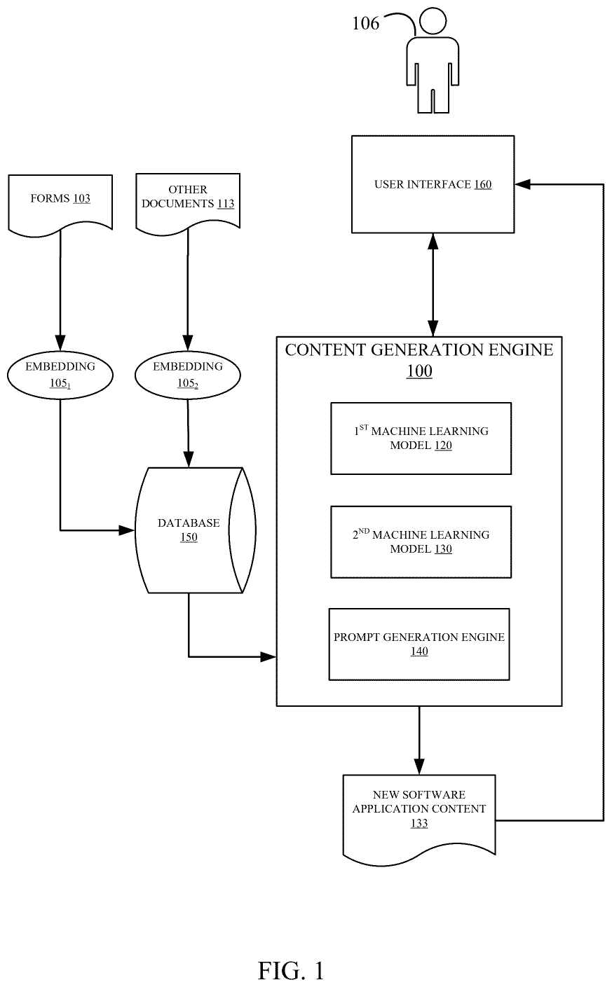

FIG. 1 is an illustration of example computing components related to automatically generating software application content.

Embeddings 105₁ and 105₂ (collectively, embeddings 105) are created of one or more forms 103 and one or more other documents 113. An embedding generally refers to a vector representation of an entity that represents the entity as a vector in n-dimensional space such that similar entities are represented by vectors that are close to one another in the n-dimensional space. Embeddings may be generated through the use of an embedding model, such as a neural network or other type of machine learning model that learns a representation (embedding) for an entity through a training process that trains the neural network based on a data set, such as a plurality of features of a plurality of entities. In one example, the embedding model comprises a Bidirectional Encoder Representations from Transformer (BERT) model, which involves the use of masked language modeling to determine embeddings. In a particular example, the embedding model comprises a Sentence-BERT model. In other embodiments, the embedding model may involve embedding techniques such as Word2Vec and GloVe embeddings. These are included as examples, and other techniques for generating embeddings are possible. Embeddings 105 may be created at a selected granularity. As a particular example, the embeddings may be created at a fifty character granularity (e.g., creating an embedding of a version of a form may involve creating multiple embeddings, such as an embedding of each successive fifty characters), although other granularities may be used.

Forms 103 are generally any type of document that a user may complete by providing information within the document, such as tax forms, medical forms, loan application forms, registration forms, and/or the like. Other documents 113 for which embeddings 105 may be created include summaries of forms, form filing instructions, documents referenced by a form (which may include other forms), interview questions designed to guide users through filing a form, software application code, and/or the like. Forms 103 and other documents 113 are generally in an electronic format that may be processed by a computer. Embeddings of forms 105₁ and embeddings of other documents 105₂ may be stored in a database 150.

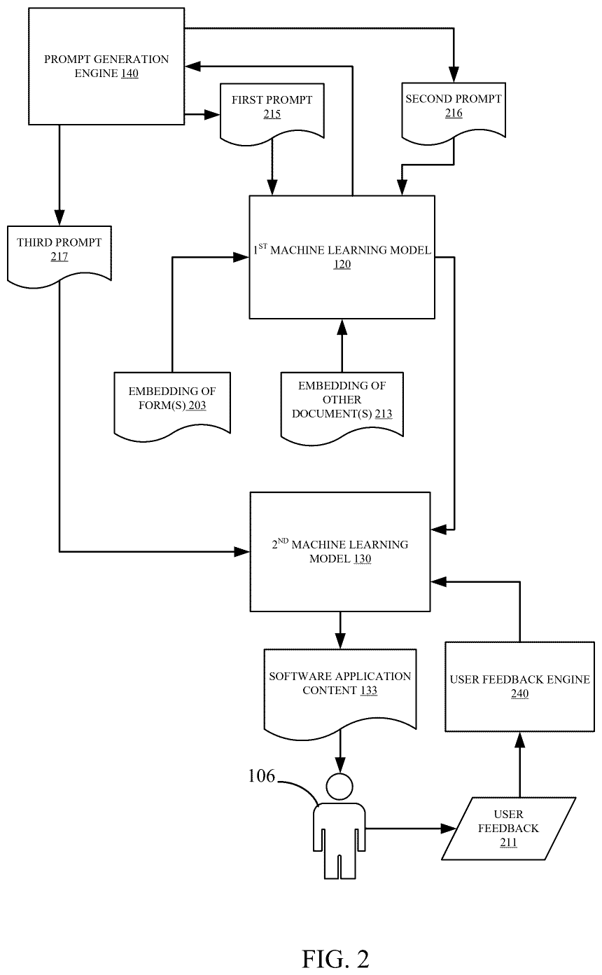

Embeddings of forms 105₁ and embeddings of other documents 105₂ from the database 150 may be provided to the content generation engine 100, which is further described below with respect to FIG. 2. The content generation engine 100 includes one or more machine learning models and a prompt generation engine 140 that generates prompts to provide to the machine learning models. The prompt generation engine 140 may comprise a component (e.g., a software component running on one or more processors) configured to populate templates according to a set of rules based on an indication of a desired function for a model and/or information extracted from a document. In some embodiments, the prompt generation engine 140 may comprise a machine learning model configured to populate templates according to a set of rules based on an indication of a desired function for a model and/or information extracted from a document. The content generation engine 100 has been trained to generate new software application content 133 based on embeddings of forms 105₁ and embeddings of other documents 105₂. New software application content 133 may include software application code, interview questions designed to guide a user through populating a form (e.g., the questions are based on the requirements of the form, and the form is populated with the user's answers to the questions), summaries of forms, form filing instructions, and/or the like. The software application content 133 may be generated in a standard file format, such as JavaScript Object Notation (JSON).

Users 106 may interact with the content generation system through a user interface 160. The user interface 160 allows the user 106 to provide the system with forms 103 and other documents 113. The users 106 also receive new software application content 133 through the user interface 160.

It is noted that while forms 103 and/or other documents 113 may be provided by the user via user interface 160 (e.g., via image capture, scanning, uploading, and/or the like), these forms and/or other documents may also come from other sources, such as being retrieved from external data sources and/or the like.

### Example of Computing Components Related to Automatically Generating Software Application Content

FIG. 2 is an illustration of example computing components related to automatically generating software application content.

As discussed above, the prompt generation engine 140 may comprise a set of rules for populating templates based on an indication of a desired function for a model and/or information extracted from a document. The templates may comprise natural language instructions with various parts that are populated based on extracted information and/or an indication of a desired action for a machine learning model. For example, if information extracted from Form A indicates that Form B must be completed along with Form A, the prompt generation engine 140 may populate the template “extract information from insert form name here” with “Form B,” resulting in a populated template containing natural language instructions to “extract information from Form B.”

In some embodiments, the prompt generation engine 140 may be provided with an indication of a desired action for the first machine learning model 120. Based on this indication, the prompt generation engine 140 may generate a first prompt 215. The first prompt 215 comprises instructions to extract information of a first type from a form. For example, it may be desired that the first machine learning model 120 extract fields from a form. Based on this desired action for the first machine learning model 120, the first prompt 215 generated by the prompt generation engine 140 may comprise natural language instructions to “extract fields from the provided form.”

The first machine learning model 120 may be, for example, a natural language processing model such as a large language model. The first machine learning model 120 may be trained to extract information from documents based on prompts and embeddings of the documents. The first prompt 215 and an embedding of one or more forms 203 may be provided to the first machine learning model 120. Based on these inputs, the first machine learning model 120 may extract information of a first type from the one or more forms. As discussed above, the first type of information extracted from the form may be fields of the form. Fields may include labeled spaces for entering a user's name, date of birth, social security number, income, and/or the like. Fields may also include multiple choice questions. For example, a tax form may have a field that asks users if anybody claims the user as a dependent. If somebody claims the user as a dependent, the user would select “yes” as the answer to the question. Providing the first machine learning model 120 with a first prompt 215 that asks it to extract fields from a form would result in the first machine learning model 120 extracting information necessary to determine what fields the form contains (e.g. a name field, a date of birth field, etc.).

According to some embodiments, the first information extracted from the form (which corresponds to the first type of information) is provided to the prompt generation engine 140. Based on this extracted information, the prompt generation engine 140 may generate a second prompt 216. The second prompt 216 comprises instructions to extract information of a second type from a form. For example, the first information extracted from the form may indicate the presence of a particular type of field in the form. Based on this information, the second prompt 216 generated by the prompt generation engine 140 may comprise natural language instructions to extract information related to that particular type of field (e.g., if a form contains an age field, the second prompt may include instructions to extract age-based eligibility information, such as a minimum required age).

In some embodiments, the second prompt 216 may be provided to the first machine learning model 120. Also, in certain embodiments, an embedding of other documents 213 may be provided to the first machine learning model 120. Based on these inputs, the first machine learning model 120 may extract information of a second type from the one or more forms. If an embedding of other documents 213 is provided, information of the second type may be extracted from these documents as well if these documents contain information of the second type. The second type of information may include information related to the fields of the form, such as software application metadata associated with a document, interview questions, and filing instructions. The first machine learning model 120 may extract information of a certain type from forms and other documents by evaluating the semantic meaning of an embedding of a document to determine whether the information within a portion of the embedding is of the certain type.

According to some embodiments, the first machine learning model 120 was trained on a large data set, such as in advance by a third party. The first machine learning model 120 may also be trained or fine-tuned for software application content 133 more particularly, such as based on historical software application content 133 that was generated in response to providing the content generation system with one or more forms and one or more other documents. For example, a training data instance may include a first prompt 215, a second prompt 216, an embedding of one or more forms 203, an embedding of other documents 213, and an embedding of software application content generated in response to the prompts, the embedding of the forms 203, the embedding of the other documents 113, and/or the like. Supervised learning techniques or semi-supervised learning techniques may be used to train or fine-tune the first machine learning model 120 based on such training data instances or other types of training data instances.

Supervised learning generally involves providing training inputs as inputs to a machine learning model. The machine learning model processes the training inputs and generates outputs based on the training inputs. The outputs are compared to known labels associated with the training inputs (e.g., ground truth labels based on historical data that is manually produced or verified) to determine the accuracy of the machine learning model, and parameters of the machine learning model are iteratively adjusted until one or more conditions are met. For instance, the one or more conditions may relate to an objective function (e.g., a cost function or loss function) for optimizing one or more variables (e.g., model accuracy). In some embodiments, the conditions may relate to whether the outputs produced by the machine learning model based on the training inputs match the known labels associated with the training inputs or whether a measure of error between training iterations is not decreasing or not decreasing more than a threshold amount. The conditions may also include whether a training iteration limit has been reached. Parameters adjusted during training may include, for example, hyperparameters, values related to numbers of iterations, weights, functions used by nodes to calculate scores, and the like. In some embodiments, validation and testing are also performed for a machine learning model, such as based on validation data and test data, as is known in the art.

According to some embodiments, the second information extracted from the form (which corresponds to the second type of information) is provided to the prompt generation engine 140. Based on the information of the first type and the information of the second type extracted from the one or more forms (and, in certain embodiments, information of the second type extracted from other documents 213), the prompt generation engine 140 may generate a third prompt 217. The third prompt 217 comprises instructions to generate software application content 133 based on the information extracted from the one or more forms (and also, in certain embodiments, information extracted from the other documents). The template of the third prompt 217 may be populated based on the first and second extracted information, resulting in a third prompt 217 that contains detailed instructions on how to generate software application content 133 (e.g., software application code, interview questions, instructions, summaries, etc.) that relates to the one or more forms.

In some embodiments, the third prompt 217 may be provided to a second machine learning model 130 along with the information extracted by the first machine learning model 120. The second machine learning model 130 may be, for example, a generative model such as a Generative Adversarial Network (GAN) or a Variational Autoencoder (VAE). The second machine learning model 130 may be trained to generate software application content 133 based on a first and second type of extracted information and a prompt. The software application content 133 generated by the second machine learning model 130 may incorporate information extracted by the first machine learning model 120. For example, if the first machine learning model 120 extracts a first type of information indicating that a form has an income field and a second type of information indicating that a user must fill out another form if the income entered into the field is above a certain level, the second machine learning model 130 may generate software application code that results in an application that asks users for their income. If the income a user enters into the application is above the certain level, the application may ask users questions based on the other form.

The second machine learning model 130 may be trained or fine-tuned using existing software application content 133 to ensure that the content that is generated is semantically and syntactically correct. In some embodiments, the second machine learning model 130 may be trained using training data that is based on manually generated content based on forms and other documents. In some embodiments, a pre-trained model may be further trained (e.g., fine-tuned) to generate software application content 133 that complies with a particular format (e.g., to generate code that fits a particular software application's code base). For example, a training data instance may include a third prompt 217, information of a first type extracted by the first machine learning model 120, information of a second type extracted by the first machine learning model 120, and an embedding of software application content 133 associated with a label including generated software application content (e.g., the label may be based on manual updates to automatically generated content, manual verification of automatically generated content, and/or manually generated content). Supervised learning techniques or semi-supervised learning techniques may be used to train or fine-tune the second machine learning model based on such training data instances or other types of training data instances.

According to some embodiments, user feedback 211 received in response to a user's evaluation of newly generated software application content 133 may be used to update the training data set. A user feedback engine 240 may prompt a user 106 to provide user feedback 211 based on the user's evaluation of the newly generated software application content 133. The user feedback 211 may include natural language feedback. The user feedback engine 210 may include a natural language processing model such as a large language model. A natural language processing model may be applied to natural language feedback in order to determine what the user 106 liked or did not like about the newly generated software application content 133, as well as any issues that need to be addressed regarding the software application content 133 (e.g., formatting). Feedback 211 may also be received in the form of a user 106 accepting or rejecting software application content 133, or a user 106 modifying newly generated software application content 133 or otherwise providing alternative software application content. The information gathered by the feedback engine 240 may then be used to re-train the first machine learning model 120 and/or the second machine learning model 130. For example, new training data may be generated for the second machine learning model 130 based on the user feedback 211 (e.g., indicating manually corrected or verified software application content) and the second machine learning model 130 may be re-trained based on the new training data for improved accuracy in an interactive feedback loop. While not shown, the first machine learning model 120 may also be re-trained in a similar manner based on user feedback 211. For example, if user feedback 211 includes a verification of newly generated software application content 133, extraction of information may be considered user-verified, and so may be used as new training data to re-train the first machine learning model 120. Similarly, if user feedback 211 indicates that the software application content 133 contains errors (e.g., it incorporates irrelevant information or omits important information), the extracted information may be used as negative training data or a modified selection of extracted information may be used as new training data to re-train the first machine learning model 120.

### Example of a Form and a Document Related to a Form That may be Used to Generate Software Application Content

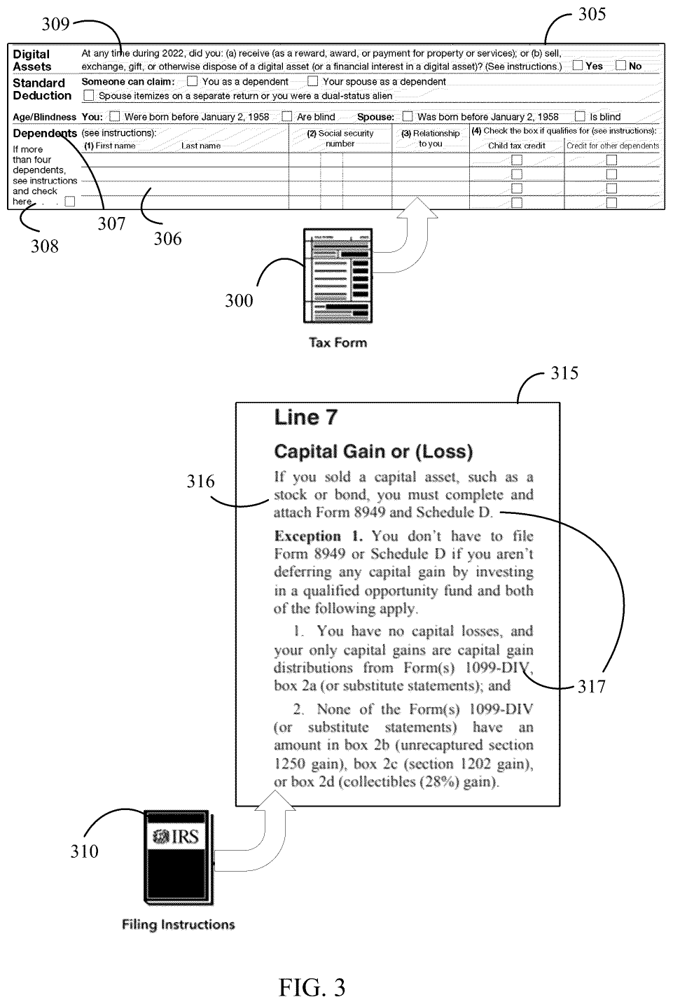

FIG. 3 depicts an example of a form 300 and a document related to a form 310 from which information may be extracted to generate software application content.

In some embodiments, the form 300 may be a tax form, as shown in FIG. 3. The contents 305 of the form 300 may be extracted by the first machine learning model. The contents 305 may include blank fields 306 such as the first name/last name fields shown in FIG. 3. When provided with an embedding of the form 300 shown in FIG. 3, based on the text “First name” and “Last name” that appears over the four rows, the first machine learning model may determine that the form 300 contains four first name/last name fields. Also, a form 300 may contain context clues and/or positional information such as headings 307 that help the first machine learning model determine the type of the field. Based on the heading 307 for the fields (“Dependents”), the first machine learning model may further determine that the four first name/last name fields 306 are for listing the people that a user claims as dependents. Further, the first machine learning model may extract additional information about the fields, such as directions 308 that are based on inputs to the fields. The directions 308 shown in FIG. 3 indicate that if the user has more than four dependents, the user should check a box and see a set of instructions associated with the form. The first machine learning model may extract information about this field from the instructions associated with the form. Based on the information extracted from this form and the instructions, the second machine learning model may generate software application content. The software application content may result in a software application that asks users to list their dependents. For example, the software application content may be an artifact (e.g., JSON file) including content such as interview questions or instructions related to the form, and the software application may use the content to present questions, instructions, and/or other information to the user in order to assist the user with completing the form. The software application may populate the first name/last name fields 306 with the first four dependents indicated by the user. Then, the software application may check the box on the form that indicates the user has more than four dependents. The software application may then prompt the user with more questions based on the information contained in the instructions that were indicated by the directions 308.

A form may also contain multiple choice fields 309. The multiple choice field 309 shown in FIG. 3 asks users if they received or disposed of digital assets in the year 2022, and the possible answers are “yes” and “no.” The multiple choice field 309 also directs users to see a set of instructions associated with the form. The first machine learning model may extract this information from the field based on the text of the field and the multiple choice boxes within the field. Based on this extracted information, the first machine learning model may extract information about this field from the instructions associated with the form. Then, based on the information extracted from this form and the instructions, the second machine learning model may generate software application content. The software application content may result in a software application that asks users to select either yes or no with regards to whether they received or disposed of digital assets in 2022. The software application may also provide the users with guidance based on the information extracted from the instructions associated with the form.

According to some embodiments, information may also be extracted from other documents related to a form 310. The document related to a form 310 shown in FIG. 3 is a set of tax filing instructions. The contents 315 of the documents related to the form 310 may be extracted by the first machine learning model. The contents 315 may include individual instructions 316. The instructions 316 may contain references to other forms 317, as does the instruction 316 shown in FIG. 3. Though not shown, forms may also contain references to other forms 317. The instructions 316 indicate that users must complete the referenced forms 317 if they sold capital assets. This information may be extracted by the first machine learning model. Upon extracting this information, the first machine learning model may then extract information from the referenced forms 317.

Based on the information extracted from one or more forms and the other related document 310 as shown in FIG. 3, the second machine learning model may generate software application content such as a JSON file containing interview questions, instructions, and/or other content related to the one or more forms. The software application content may result in a software application that guides a user to either complete or omit Form 8949 and Schedule D based on the user's capital gains for the year.

### Example Operations Related to Generating Software Application Content

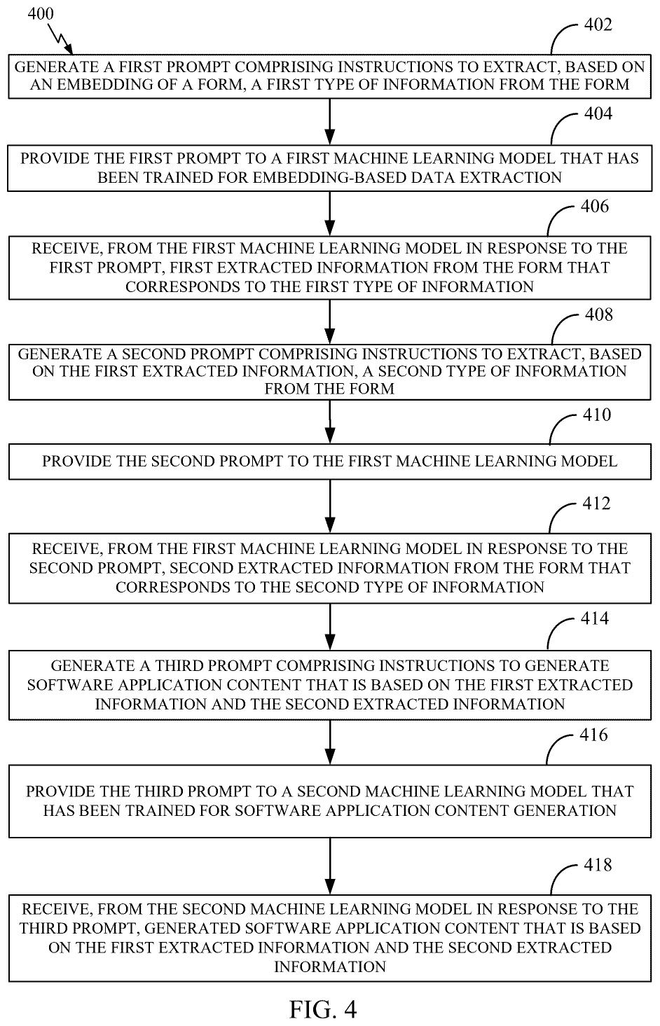

FIG. 4 depicts example operations 400 related to generating software application content. For example, operations 400 may be performed by one or more of the components described in FIG. 1 and FIG. 2.

Operations 400 begin at step 402 with generating a first prompt comprising instructions to extract, based on an embedding of a form, a first type of information from the form. In some embodiments, the first type of information extracted from the form comprises fields of the form. Certain embodiments provide that the first prompt may be generated based on an indication of a desired action for the first machine learning model, such as extracting fields from a tax form. According to certain embodiments, the form may be a tax form.

Operations 400 continue at step 404 with providing the first prompt to a first machine learning model that has been trained for embedding-based data extraction. Certain embodiments provide that the first machine learning model is a natural language processing model such as a large language model.

Operations 400 continue at step 406 with receiving, from the first machine learning model in response to the first prompt, first extracted information from the form that corresponds to the first type of information.

Operations 400 continue at step 408 with generating a second prompt comprising instructions to extract, based on the first extracted information, a second type of information from the form. In some embodiments, the second prompt may comprise a template that is populated with the first information extracted from the form. According to certain embodiments, the second type of information comprises information about fields of a form.

Operations 400 continue at step 410 with providing the second prompt to the first machine learning model.

Operations 400 continue at step 412 with receiving, from the first machine learning model in response to the second prompt, second extracted information from the form that corresponds to the second type of information. In certain embodiments, the first machine learning model may also be trained to extract related information from the one or more other documents based on determining that the related information is related to the form. According to certain embodiments, the related documents may include one or more interview questions designed to automatically guide a user through populating the form. Certain embodiments provide that the related information comprises software application metadata associated with the one or more other documents. In some embodiments, the related information comprises tax filing instructions.

Operations 400 continue at step 414 with generating a third prompt comprising instructions to generate software application content that is based on the first extracted information and the second extracted information.

Operations 400 continue at step 416 with providing the third prompt to a second machine learning model that has been trained for software application content generation. In some embodiments, the second machine learning model is a generative machine learning model such as a Generative Adversarial Network (GAN) or a Variational Autoencoder (VAE). According to some embodiments, the second machine learning model may be retrained based on user feedback with respect to the generated software application content. Certain embodiments provide that the second machine learning model may be trained to generate software application content based on information related to a form that is extracted from other documents.

Operations 400 continue at step 418 with receiving, from the second machine learning model in response to the third prompt, generated software application content that is based on the first extracted information and the second extracted information. In some embodiments, the software application content comprises a JavaScript Object Notation (JSON) file. Certain embodiments provide that the software application content comprises one or more newly generated interview questions designed to automatically guide a user through populating the form.

### Example of a Processing System for Automatically Generating Software Application Content

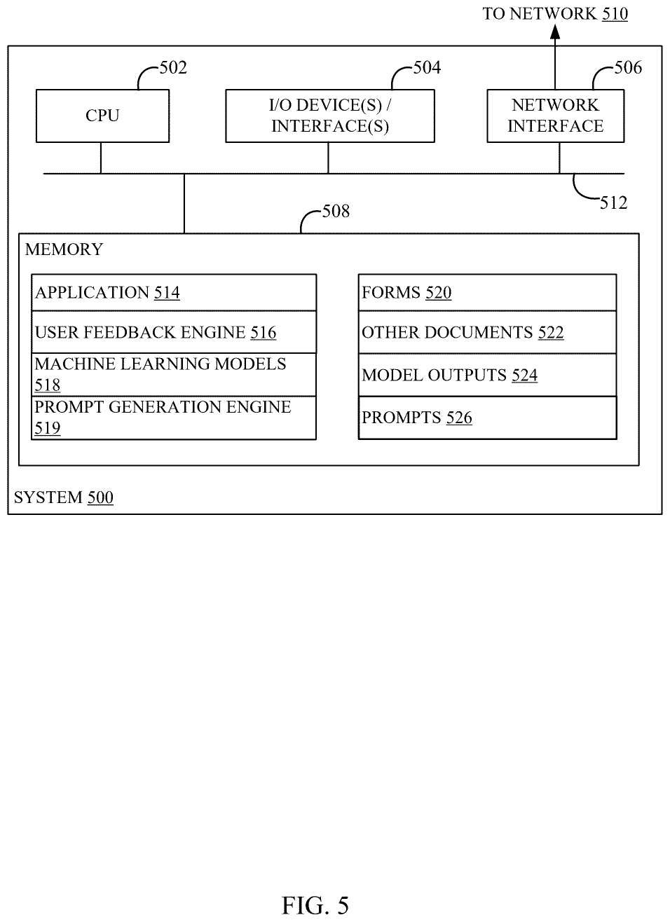

FIG. 5 illustrates an example system 500 with which embodiments of the present disclosure may be implemented. For example, system 500 may be configured to perform operations 400 of FIG. 4 and/or to implement one or more components as in FIG. 1 or FIG. 2.

System 500 includes a central processing unit (CPU) 502, one or more I/O device interfaces that may allow for the connection of various I/O devices 504 (e.g., keyboards, displays, mouse devices, pen input, etc.) to the system 500, network interface 506, a memory 508, and an interconnect 512. It is contemplated that one or more components of system 500 may be located remotely and accessed via a network 510. It is further contemplated that one or more components of system 500 may comprise physical components or virtualized components.

CPU 502 may retrieve and execute programming instructions stored in the memory 508. Similarly, the CPU 502 may retrieve and store application data residing in the memory 508. The interconnect 512 transmits programming instructions and application data, among the CPU 502, I/O device interface 504, network interface 506, and memory 508. CPU 502 is included to be representative of a single CPU, multiple CPUs, a single CPU having multiple processing cores, and other arrangements.

Additionally, the memory 508 is included to be representative of a random access memory or the like. In some embodiments, memory 508 may comprise a disk drive, solid state drive, or a collection of storage devices distributed across multiple storage systems. Although shown as a single unit, the memory 508 may be a combination of fixed and/or removable storage devices, such as fixed disc drives, removable memory cards or optical storage, network attached storage (NAS), or a storage area-network (SAN).

As shown, memory 508 includes application 514, user feedback engine 516, machine learning models 518, and prompt generation engine 519. Application 514 may be representative of an application corresponding to the software application content 133 of FIG. 1 and FIG. 2. In some embodiments, user feedback engine 516 may be representative of user feedback engine 240 of FIG. 2. Machine learning models 518 may be representative of the first machine learning model 120 of FIG. 1 and FIG. 2, and/or the second machine learning model 130 of FIG. 1 and FIG. 2. Prompt generation engine 519 may be representative of prompt generation engine 140 of FIG. 1 and FIG. 2.

Memory 508 further comprises forms 520, which may correspond to forms 103 of FIG. 1. Memory 508 further comprises other documents 522 which may correspond to other documents 113 found in FIG. 1. Memory 508 further comprises model outputs 524, which may include information extracted by first machine learning model 120 of FIG. 1 and FIG. 2 as well as software application content 133 of FIG. 1 and FIG. 2. Memory 508 further comprises prompts 526, which may correspond to the first prompt 215, the second prompt 216, and/or the third prompt 217 of FIG. 2.

It is noted that in some embodiments, system 500 may interact with one or more external components, such as via network 510, in order to retrieve data and/or perform operations.

### Additional Considerations

The preceding description provides examples, and is not limiting of the scope, applicability, or embodiments set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The preceding description is provided to enable any person skilled in the art to practice the various embodiments described herein. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and other operations. Also, “determining” may include receiving (e.g., receiving information), accessing (e.g., accessing data in a memory) and other operations. Also, “determining” may include resolving, selecting, choosing, establishing and other operations.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A processing system may be implemented with a bus architecture. The bus may include any number of interconnecting buses and bridges depending on the specific application of the processing system and the overall design constraints. The bus may link together various circuits including a processor, machine-readable media, and input/output devices, among others. A user interface (e.g., keypad, display, mouse, joystick, etc.) may also be connected to the bus. The bus may also link various other circuits such as timing sources, peripherals, voltage regulators, power management circuits, and other types of circuits, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media, such as any medium that facilitates transfer of a computer program from one place to another. The processor may be responsible for managing the bus and general processing, including the execution of software modules stored on the computer-readable storage media. A computer-readable storage medium may be coupled to a processor such that the processor can read information from, and write information to, the storage medium. In the alternative, the storage medium may be integral to the processor. By way of example, the computer-readable media may include a transmission line, a carrier wave modulated by data, and/or a computer readable storage medium with instructions stored thereon separate from the wireless node, all of which may be accessed by the processor through the bus interface. Alternatively, or in addition, the computer-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module, it will be understood that such functionality is implemented by the processor when executing instructions from that software module.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for generating software application content related to forms, comprising:
generating a first prompt comprising instructions to extract, based on an embedding of a form, a first type of information from the form;
providing the first prompt to a first machine learning model that has been trained for embedding-based data extraction;
receiving, from the first machine learning model in response to the first prompt, first extracted information from the form that corresponds to the first type of information;
generating a second prompt comprising instructions to extract, based on the first extracted information, a second type of information from the form;
providing the second prompt to the first machine learning model;
receiving, from the first machine learning model in response to the second prompt, second extracted information from the form that corresponds to the second type of information;
generating a third prompt comprising instructions to generate software application content that is based on the first extracted information and the second extracted information;
providing the third prompt to a second machine learning model that has been trained for software application content generation; and
receiving, from the second machine learning model in response to the third prompt, generated software application content that is based on the first extracted information and the second extracted information.

2. The method of claim 1, further comprising providing embeddings of one or more other documents along with the first prompt to the first machine learning model, wherein the first machine learning model extracts related information from the one or more other documents based on determining that the related information is related to the form.

3. The method of claim 2, further comprising providing the related information that was extracted by the first machine learning model along with the third prompt to the second machine learning model, wherein the generated software application content is based further on the related information.

4. The method of claim 3, wherein the one or more other documents include one or more interview questions designed to automatically guide a user through populating the form.

5. The method of claim 3, wherein the related information comprises software application metadata associated with the one or more other documents.

6. The method of claim 3, wherein the form is a tax form, and the related information comprises tax filing instructions.

7. The method of claim 1, wherein the first machine learning model is a large language model.

8. The method of claim 1, wherein the second machine learning model is a generative machine learning model.

9. The method of claim 1, wherein the second machine learning model is retrained based on user feedback with respect to the generated software application content.

10. The method of claim 1, wherein the first type of information comprises fields, and the second type of information comprises information about the fields.

11. The method of claim 1, wherein the software application content comprises a JavaScript Object Notation (JSON) file.

12. The method of claim 1, wherein the software application content comprises one or more newly generated interview questions designed to automatically guide a user through populating the form.

13. A system for generating software application content related to forms, comprising:
one or more processors; and
a memory comprising instructions that, when executed by the one or more processors, cause the system to:
generate a first prompt comprising instructions to extract, based on an embedding of a form, a first type of information from the form;
provide the first prompt to a first machine learning model that has been trained for embedding-based data extraction;
receive, from the first machine learning model in response to the first prompt, first extracted information from the form that corresponds to the first type of information;
generate a second prompt comprising instructions to extract, based on the first extracted information, a second type of information from the form;
provide the second prompt to the first machine learning model;
receive, from the first machine learning model in response to the second prompt, second extracted information from the form that corresponds to the second type of information;
generate a third prompt comprising instructions to generate software application content that is based on the first extracted information and the second extracted information;
provide the third prompt to a second machine learning model that has been trained for software application content generation; and
receive, from the second machine learning model in response to the third prompt, generated software application content that is based on the first extracted information and the second extracted information.

14. The system of claim 13, further comprising providing embeddings of one or more other documents along with the first prompt to the first machine learning model, wherein the first machine learning model extracts related information from the one or more other documents based on determining that the related information is related to the form.

15. The system of claim 14, further comprising providing the related information that was extracted by the first machine learning model along with the third prompt to the second machine learning model, wherein the generated software application content is based further on the related information.

16. The system of claim 15, wherein the one or more other documents include one or more interview questions designed to automatically guide a user through populating the form.

17. The system of claim 15, wherein the related information comprises software application metadata associated with the one or more other documents.

18. The system of claim 15, wherein the form is a tax form, and the related information comprises tax filing instructions.

19. The system of claim 13, wherein the first machine learning model is a large language model.

20. A non-transitory computer-readable medium comprising instructions that, when executed by one or more processors of a computing system, cause the computing system to:
generate a first prompt comprising instructions to extract, based on an embedding of a form, a first type of information from the form;
provide the first prompt to a first machine learning model that has been trained for embedding-based data extraction;
receive, from the first machine learning model in response to the first prompt, first extracted information from the form that corresponds to the first type of information;
generate a second prompt comprising instructions to extract, based on the first extracted information, a second type of information from the form;
provide the second prompt to the first machine learning model;
receive, from the first machine learning model in response to the second prompt, second extracted information from the form that corresponds to the second type of information;
generate a third prompt comprising instructions to generate software application content that is based on the first extracted information and the second extracted information;
provide the third prompt to a second machine learning model that has been trained for software application content generation; and
receive, from the second machine learning model in response to the third prompt, generated software application contect that is based on the first extracted information and the second extracted information.
